(19) United States
(12) Patent Application Publication
(10) Pub. No.: US 2004/0189837 A1
(43) Pub. Date: Sep. 30, 2004

(54) Image capturing apparatus and program

(75) Inventor: Toshihito Kido, Matsubara-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/672,942

(22) Filed: Sep. 26, 2003

(30) Foreign Application Priority Data
Mar. 31, 2003 (JP) P2003-093684

(51) Int. Cl. H04N 5/217; H04N 3/14; H04N 5/335

(52) U.S. Cl. 348/241; 348/300; 348/297; 348/208.99

(57) ABSTRACT

The present invention provides an image capturing apparatus capable of fully utilizing the performance of an image sensor and obtaining an image having good picture quality. In an image recording standby state, on the basis of operation of an operation part by the user, a CCD obtains first and second image signals for detection while setting different exposure amounts at predetermined intervals during a period from start of an image recording preparing operation to start of an image recording operation. A saturation voltage detector detects the saturation voltage of the CCD on the basis of the first and second image signals for detection. After that, an AE/WB controller calculates and sets the minimum value of the amplification factor of an analog image signal in an analog amplifier on the basis of the saturation voltage of the CCD. In the AE/WB controller, automatic exposure control is performed so that the amplification factor of the analog amplifier becomes the set minimum value as much as possible.

This application is based on application No. 2003-093684 filed in Japan, the contents of which are hereby incorporated by reference.

### BACKGROUND OF THE INVENTION

1. Field of the Invention

The present invention relates to a technique of controlling amplification of an analog signal in an image capturing apparatus.

2. Description of the Background Art

Generally, a solid-state image capturing device (image sensor) such as a CCD or CMOS is used in a digital camera or the like. In recent years, in the image sensor, as pixel density increases and miniaturization advances, it is becoming more difficult to dissipate heat. On the other hand, as the speed of reading an image signal increases, a heat generation amount tends to increase. FIG. 25 is a diagram showing the relation between current passing time and temperature rise in an image sensor. As shown in FIG. 25, for example, the temperature of the image sensor gradually increases immediately after start of passing of current. By current passing for a long time, there is a case such that the temperature of the image sensor becomes higher than the ambient temperature by about 20° C.

The permissible amount of a charge signal which can be accumulated in each of pixels in the image sensor (hereinafter, referred to as “pixel saturation voltage”) tends to decrease with the temperature rises. FIG. 26 is a diagram illustrating the relation between the pixel saturation voltage and the temperature of the image sensor. FIG. 26 shows the relation between the pixel saturation voltage and the temperature of the image sensor with respect to high pixel saturation voltage (straight line LA), average pixel saturation voltage (straight line LB), and low pixel saturation voltage (straight line LC) in consideration of individual differences of image sensors. When it is assumed that the maximum temperature in the environment using the image capturing apparatus is about 40° C., the temperature of the image sensor may increase up to about 60° C. As shown in FIG. 26, when variations of the individual differences of the image sensors are considered, there is the possibility that the pixel saturation voltage drops to about 370 mV (point P0). When it is assumed that an A/D converter converts an analog signal of 0 to 1023 mV supplied from the image sensor into a digital signal of 0 to 1023 tones by making 1 mV correspond to 1 tone, to make the brightness of the subject accurately reflected in the digital signal obtained by the A/D conversion, about 370 mV as the maximum value of a charge signal accumulated in the image sensor has to be amplified to at least 1023 mV before the AID conversion.

Concretely, the amplification factor (hereinafter, also referred to as “gain set value”) before AID conversion has to be set to at least about 2.76 (about 1023 mV/370 mV). In the case where the gain set value is set to about 2.76, to avoid a phenomenon that a number of pixels exceed the maximum brightness value in a captured image, that is, overexposure, exposure (for example, sensitivity) is set so that a charge signal does not exceed 370 mV in each of the pixels in the image sensor. Further, in this case, the minimum value of the gain set value (hereinafter, referred to as “minimum gain set value”) is set to 2.76 and the gain set value is set so as to change the gain set value at equal to or higher than 2.76 in accordance with the brightness of the subject or exposure setting.

Setting of the gain set value in which rise in the temperature of the image sensor is considered is employed in a general image capturing apparatus. However, when the gain set value is set to a large value in consideration of rise in temperature of the image sensor, a noise component which occurs in a signal is more amplified. It results in deterioration in the signal-to-noise ratio (S/N ratio) in an image signal.

On the other hand, as shown in FIGS. 25 and 26, in the image sensor, immediately after start of current passing, temperature rise is relatively small and the pixel saturation voltage is relatively high, so that the gain set value can be set to a relatively small value. For example, as shown in FIG. 26, when the temperature of the image sensor is about 30° C., the pixel saturation voltage is about 550 mV (point P1). In such a case, the minimum gain set value can be set to about 1.86 (about 1023 mV/550 mV).

However, it is difficult to directly measure the temperature of a pixel in the image sensor. Consequently, in a general image capturing apparatus, as described above, the minimum gain set value is set to a large value in consideration of rise in the temperature of the image sensor and the exposure is set so that a charge signal does not exceed a predetermined voltage in each pixel. As a result, from the viewpoint of obtaining an image as good as possible by improving the S/N ratio, it can be said that the general image capturing apparatus does not fully utilize the performance (dynamic range) of the image sensor.

In order to address such a problem, a technique of adding a circuit to an image sensor is proposed. The circuit corrects the temperature characteristic of a saturation charge in an image sensor by utilizing dependency on temperature of the forward bias of a diode.

However, the circuit is added to the image sensor from the outside. It is therefore difficult to make the temperature of the circuit and the temperature of a pixel in the image sensor coincide with each other. Since a new circuit is added, the size of the circuit increases and thus the image capturing apparatus becomes bulky.

### SUMMARY OF THE INVENTION

The present invention is directed to an image capturing apparatus.

According to one aspect of the present invention, the image capturing apparatus includes: an image capturing part for capturing an image signal of a subject; a detector for detecting a saturation voltage of the image capturing part; an analog amplifier for amplifying the image signal; and a controller for controlling an amplification factor of the analog amplifier on the basis of the saturation voltage.

Since the amplification of an analog image signal is controlled in accordance with the saturation voltage of the image sensor to be detected, it is possible to provide an image capturing apparatus capable of fully utilizing the performance of the image sensor and obtaining an image having high picture quality.

The present invention is also directed to a program for an image capturing apparatus.

Therefore, an object of the present invention is to provide an image capturing apparatus capable of fully utilizing the performance of the image sensor and obtaining an image of an excellent picture quality.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the functional configuration of an image capturing apparatus according to a first preferred embodiment of the present invention;

FIG. 2 is a diagram for describing reading of a CCD;

FIG. 3 is a diagram for describing reading of the CCD;

FIG. 4 is a timing chart for describing charge accumulation and reading of the CCD;

FIG. 5 is a flowchart showing a flow of detecting a saturation voltage and calculating and setting a minimum gain set value;

FIG. 6 is a flowchart showing a flow of detecting the saturation voltage and calculating and setting the minimum gain set value;

FIG. 7 is a diagram for describing a method of detecting the maximum value of a pixel value;

FIG. 8 is a diagram for describing detection of the maximum value of a pixel value;

FIG. 9 is a diagram for describing detection of the maximum value of a pixel value;

FIG. 10 is a diagram for describing detection of the maximum value of a pixel value;

FIG. 11 is a timing chart showing timings of detecting a saturation voltage and calculating and setting the minimum gain set value;

FIG. 12 is a program chart showing the relation between subject brightness and an AE control value;

FIG. 13 is a program chart showing the relation between the subject brightness and the AE control value;

FIG. 14 is a diagram showing the relation between the subject brightness and the AE control value;

FIG. 15 is a diagram showing the relation between the subject brightness and the AE control value;

FIG. 16 is a diagram for describing reading of a CCD in a second preferred embodiment;

FIG. 17 is a diagram for describing reading of a CCD in the second preferred embodiment;

FIG. 18 is a timing chart for describing charge accumulation and reading of the CCD in the second preferred embodiment;

FIG. 19 is a diagram for describing mixture of charge signals in a CCD in a third preferred embodiment;

FIG. 20 is a flowchart showing a flow of detecting a saturation voltage and calculating and setting the gain set value in the third preferred embodiment;

FIG. 21 is a flowchart showing a flow of detecting the saturation voltage and calculating and setting the gain set value in the third preferred embodiment;

FIG. 22 is a timing chart showing timings of charge accumulation and reading of a CCD and emission of light in a fourth preferred embodiment;

FIG. 23 is a timing chart showing timings of charge accumulation and reading of a CCD and emission of light in a fifth preferred embodiment;

FIG. 24 is a diagram for describing reading of a charge signal in a CCD according to a modification;

FIG. 25 is a diagram illustrating the relation between current passing time and temperature rise in an image sensor; and

FIG. 26 is a diagram illustrating the relation between saturation voltage and temperature of the image sensor.

### DESCRIPTION OF THE PREFERRED EMBODIMENTS

Hereinafter, preferred embodiments of the present invention will be described with reference to the drawings.

First Preferred Embodiment

Functional Configuration of Image Capturing Apparatus

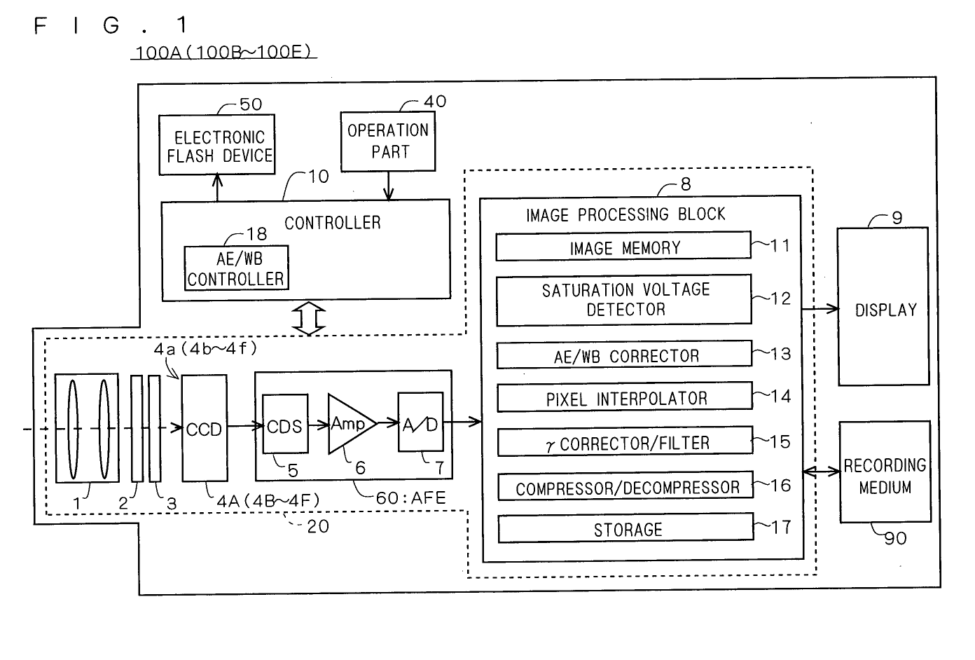

FIG. 1 is a block diagram showing the functional configuration of an image capturing apparatus 100A according to a first preferred embodiment of the present invention.

The image capturing apparatus 100A has mainly a controller 10 which overall controls each component in the image capturing apparatus 100A, an image capturing function part 20, a display 9, an operation part 40 and an electronic flash device 50. To the image capturing apparatus 10A, a recording medium 90 such as a memory card can be inserted.

The image capturing function part 20 has a taking lens 1, a diaphragm 2, a shutter 3, an image capturing device (in this case, CCD image sensor) 4A, an Analog Front End (AFE) 60 and an image processing block 8.

The taking lens 1 forms an optical image of a subject on the image sensing face of the CCD image sensor (hereinafter, referred to as “CCD”) 4A and drives the lenses on the basis of auto-focus (AF) control of the controller 10. Information of focal length “F” of the taking lens 1 is transmitted from the taking lens 1 to an AE/WB controller 18 (which will be described later) in the controller 10.

The diaphragm 2 adjusts an amount of exposure of the CCD 4A by interrupting the optical path of an optical image formed by the taking lens 1 step by step. Under control of the controller 10, the diaphragm 2 is controlled so as to be stopped down when the subject is bright (increase in the f number) and a light amount is too large, and so as to be open when the subject is dark and the light amount is too small (decrease in the f number).

The shutter 3 interrupts the optical path extending from the taking lens 1 to the CCD 4A after charge accumulation in the CCD 4A is started, thereby adjusting time (exposure time) of forming an optical image of the subject on the image sensing face of the CCD 4A. Under control of the controller 10, the shutter 3 is controlled so as to shorten time (exposure time) in which the optical path is open when the subject is bright and the light amount is too large and so as to extend time in which the optical path is open when the subject is dark and the light amount is too small. In an image recording standby state, the shutter 3 leaves the optical path extending from the taking lens 1 to the CCD 4A open to obtain a live view image or the like. The time of period from start of the charge accumulation in the CCD 4A until interruption of the optical path by the shutter 3 will be expressed as a shutter speed value.

The CCD 4A photoelectrically converts an optical image formed on the image sensing face of the CCD 4A by the taking lens 1 to thereby obtain an analog image signal of the subject. The CCD 4A is provided with a light-reception part 4a on its face (image sensing face) facing the taking lens 1. In the light-reception part 4a, a plurality of pixels are arranged. The CCD 4A and the AFE 60 are connected to each other so that signals can be transmitted between them.

The CCD 4A has a tolerance amount of a charge signal which can be accumulated in each pixel (hereinafter, referred to as “pixel saturation voltage”). There is the possibility that the maximum value (hereinafter, referred to as “transfer path saturation voltage”) of a charge signal which can be transferred via a charge transfer path (such as vertical CCD or horizontal CCD) becomes lower than a pixel saturation voltage depending on designing and manufacturing parameters. The pixel saturation voltage of the image capturing device (image sensor) and the transfer path saturation voltage will be also simply generically referred to as “saturation voltage” hereinafter.

The CCD 4A has a mode of reading charge signals stored in all of pixels as an image signal at the time of image recording (hereinafter, referred to as “image recording mode”) and a mode of reading an image signal at high speed (hereinafter, referred to as high-speed read image signal”) to generate a live view image in an image recording standby state before the image capturing for recording (hereinafter, referred to as “high-speed reading mode”). The CCD 4A further includes a mode of reading an image signal to detect the saturation voltage (hereinafter, referred to as “reading mode for detection”). A method of reading a charge signal in the high-speed reading mode and the reading mode for detection will be described in detail later.

The AFE 60 is constructed as an LSI (Large-Scale Integration) having a CDS (Correlated Double Sampler) 5, an analog amplifier (Amp) 6 and an ADC (A/D converter) 7. An analog image signal outputted from the CCD 4A is sampled by the CDS 5 on the basis of a sampling signal from a timing generating circuit (not shown) and desirably amplified by the amplifier 6. The amplification factor (gain set value) of the amplifier 6 can be changed under control of the controller 10. For example, based on the saturation voltage of the CCD 4A, the amplification factor of the amplifier 6 is controlled. Detection of the saturation voltage of the CCD 4A and control on the gain set value will be described later in detail.

The analog signal amplified by the amplifier 6 is converted by the A/D converter 7 to, for example, a digital signal of 10 bits and the digital signal is sent to the image processing block 8. For example, in the case where the analog signal is converted to a digital image signal of 10 bits, the digital image signal outputted from the A/D converter 7 is an image signal having information indicative of a pixel value (brightness value) of 0 to 1023.

The image processing block 8 includes an image memory 11, a saturation voltage detector 12, a metering (AE) and white balance correcting (WB) part 13, a pixel interpolator 14, a γ corrector/filter 15, a compressor/decompressor 16, and a storage 17.

The image memory 11 takes the form of, for example, a semiconductor memory and temporarily stores a digital image signal obtained by A/D conversion of the A/D converter 7. The parts in the image processing block 8 perform various data processes by using an image signal temporarily stored in the image memory 11. A high-speed read image signal HSP stored in the image memory 11 is also outputted to the controller 10 for AE/WB control. The storage 17 is a memory for storing various data.

The saturation voltage detector 12 detects the saturation voltage of the CCD 4A under control of the controller 10. The saturation voltage detected by the saturation voltage detector 12 is transferred to the controller 10 where a gain set value according to the saturation voltage is set. For example, when the saturation voltage of the CCD 4A is relatively high, by decreasing sensitivity setting, the signal level (voltage) of the image signal outputted from the CCD 4A can be made high, so that a relatively low gain set value is set. On the other hand, when the saturation voltage of the CCD 4A is relatively low, the signal level of the image signal outputted from the CCD 4A becomes low, so that a relatively high gain set value is set. Detection of the saturation voltage will be described in detail later.

The AE/WB part 13 performs WB correction and photometry on the image signal subjected to the A/D conversion obtained in the image recording mode and the high-speed reading mode on the basis of the AE/WB control of the controller 10.

The pixel interpolator 14 performs an interpolating process by estimating information of dropout colors of each pixel on the basis of pixels values in the periphery.

The γ corrector/filter 15 performs various imaging processes such as a γ correction for obtaining natural tones and a filter process for contour emphasis, noise reduction, or the like. Specifically, the γ corrector/filter 15 performs a filtering process (noise reducing process) for reducing noise on the image signal obtained by the CCD 4A. The noise reducing process can be achieved by means of a general low-pass filter, median filter or the like.

Under control of the controller 10, based on the saturation voltage detected by the saturation voltage detector 12, the image process such as noise reducing process in the γ corrector/filter 15 is changed. For example, when the saturation voltage of the CCD 4A is relatively high, the gain set value becomes relatively low and the S/N ratio of an image signal inputted to the γ corrector/filter 15 becomes relatively high, so that the noise reducing process which is relatively light is performed. On the other hand, when the saturation voltage of the CCD 4A is relatively low, the gain set value becomes relatively high and the S/N ratio of an image signal becomes relatively low, so that the noise reducing process which is relatively heavy is performed.

Concretely, when the gain set value is set to a value of 2 or less, the noise reducing process is not performed at all. When the gain set value is set to a value which is larger than 2 and equal to or smaller than 4, the relatively light noise reducing process is performed. Further, when the gain set value is set to a value larger than 4, the noise reducing process which is relatively heavy is performed. As a result, when the gain set value is relatively small, the noise reducing process is performed lightly. Thus, a fine image can be obtained.

The compressor/decompressor 16 performs, for example, a compressing process in the JPEG method on the image signal subjected to the AE/WB part 13 and the γ corrector/filter 15 at the time of image capturing for recording, and the resultant is stored as image data into the recording medium 90. The compressor/decompressor 16 decompresses image data stored in the recording medium 90 so as to be reproduced and displayed on the display 9 which will be described later.

The display 9 has an LCD and can display an image based on an image signal obtained by the CCD 4A (display a live view image) and an image based on image data stored in the recording medium 90.

The operation part 40 has a shutter start button (referred as “shutter button” hereinafter), a mode switching button and the like.

The shutter button is a two-stage switch capable of detecting a halfway pressed state (hereinafter, referred to as “S1 state”) and a fully depressed state (“hereinafter, referred to as “S2 state”). When the shutter button is set to the S1 state in the image recording standby state, the lens driving for AF is started. The operations including the general AF control, the AE control and the WB control (hereinafter, referred to as “image recording preparing operation”) are executed. When the shutter button is set in the S2 state, an operation (hereinafter, referred to as “image recording operation”) of compressing an image signal obtained by the CCD 4A and subjected to the imaging process by the compressor/decompressor 16 and storing the compressed image signal into the recording medium 90 is executed. That is, the shutter button instructs start of the image recording preparing operation and the image capturing for recording operation on the basis of an operation of the user. The state where the shutter button is not depressed and which is not the S1 and S2 states will be referred to as an OFF state later.

The mode switching button is used to switch the mode between “high S/N ratio priority mode” and “normal mode” on the basis of depressing operation of the user. The “high S/N ratio priority mode” is a mode of setting a gain set value (sensitivity) as low as possible in accordance with the saturation voltage of the CCD 4A to assure a high S/N ratio as much as possible. On the other hand, the “normal mode” is, as employed in a general image capturing apparatus, a mode of setting a predetermined minimum value Gₘᵢₙ of the gain set value in consideration of the saturation voltage of the CCD 4A which decreases as the temperature rises. In this case, the minimum value of the saturation voltage of the CCD 4A which is assumed in association with the temperature rise is set as a predetermined value Dₘᵢₙ.

The electronic flash device 50 is used to emit light to the subject on the basis of control of the controller 10. In the following, image capturing with flash light from the electronic flash device 50 to the subject will be referred to as “flash image capturing” and image capturing without flash light of the electronic flash device 50 will be referred to as “normal image capturing”.

The controller 10 is a part which includes a CPU, a ROM and a RAM and controls the parts of the image capturing apparatus 100A in a centralized manner. In the controller 10, when a program stored in the ROM is loaded into the CPU, various functions are realized. The controller 10 also has the AE/WB controller 18. The AE/WB controller 18 is one of the functions of the controller 10 and is shown as a function realized as concrete means.

The AE/WB controller 18 calculates values (AE control value and WB control value) for performing AE control and WB correction on the basis of the high-speed read image signal HSP sent from the image memory 11. For example, an image based on the high-speed read image signals HSP is divided into a plurality of blocks, multi-division light metering for calculating light metering data is performed on the block unit basis, and the brightness of the subject (subject brightness) is detected. As a concrete process in detection of the subject brightness, each color component value (brightness value of each color component) of each pixel specified by an image signal given by R, G and B is averaged in a whole image and is calculated as a subject brightness value so as to correspond to an integer value ranging from 0 to 1023.

With respect to AE, based on the calculated subject brightness value, the f number of aperture stop and shutter speed value are determined so that exposure becomes proper. In the case where a proper exposure amount cannot be set when the subject brightness is low, the gain set value is obtained so that improper exposure due to insufficient exposure is corrected by adjusting the level of an image signal by the amplifier 6. In this case, the f number, shutter speed value, gain set value, and the like correspond to AE control values. With respect to WB correction, based on the brightness value of each color component calculated, a WB control value is determined so that white balance (WB) becomes proper. In the AE/WB controller 18, the AE and WB control values are obtained according to a program stored in the ROM in the controller 10.

The AE/WB controller 18 makes the AE control value calculating method in the high S/N ratio priority mode and that in the normal mode different from each other. For example, when the normal mode is set, as described above, the minimum value Gₘᵢₙ of the gain set value (hereinafter, referred to as “minimum gain set value”) is set in consideration of the saturation voltage of the CCD 4A which decreases with rise in temperature, and a gain set value equal to or larger than the minimum value is used for image capturing for recording. On the other hand, when the high S/N ratio priority mode is set, the minimum gain set value according to the saturation voltage of the CCD 4A is set and a gain set value equal to or larger than the minimum value is used at the time of image capturing for recording. The AE in the high S/N ratio priority mode will be described later with reference to a program chart indicative of the relation between subject brightness and the AE control value.

In the AE/WB controller 18, for example, when the calculated subject brightness is equal to or lower than a predetermined threshold, it is determined so that the electronic flash device 50 emits light and AE in the flash image capturing is performed.

Concretely, before image capturing for recording, the electronic flash device 50 performs pre-light emission under control of the AE/WB controller 18. The pre-light emission is not light emission for recording image but is light emission for obtaining a subject brightness value at the time of light emission. The pre-light emission has a preset light emission amount (light emission time) which is smaller than the light emission amount of image capturing for recording. The AE/WB controller 18 calculates the subject brightness with respect to an image signal obtained by reading the charge signal accumulated in the CCD 4A in the high-speed reading mode at the time of pre-light emission. Further, the AE/WB controller 18 determines a light emission amount for image recording from the light emission amount at the time of pre-emission, AE control values (gain set value, number and shutter speed value), and subject brightness value.

With respect to WB correction in flash image capturing, preset value for flash image capturing or the like is employed as a WB control value.

The AE and WB control values calculated by the AE/WB controller 18 are sent to the amplifier 6 and AE/WB part 13 in accordance with a reading state of the image signal from the CCD 4A.

The controller 10 has various functions such as a function of controlling the operation of detecting the saturation voltage of the CCD 4A, a function of controlling the AF operation, and a function of performing the image recording preparing operation and image recording operation in accordance with depression of the shutter button. Reading of Charge Signal in CCD

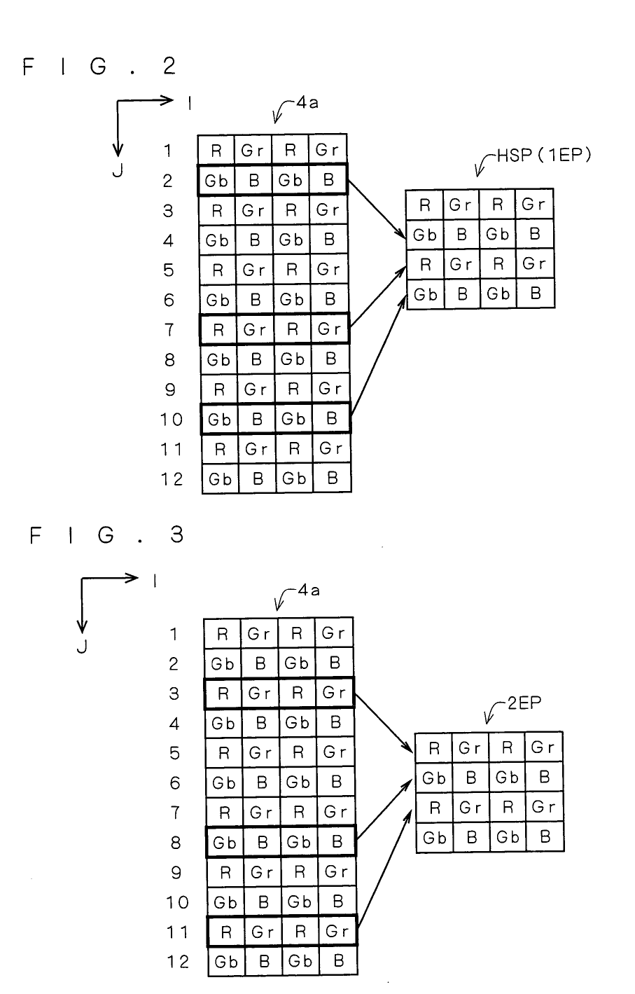

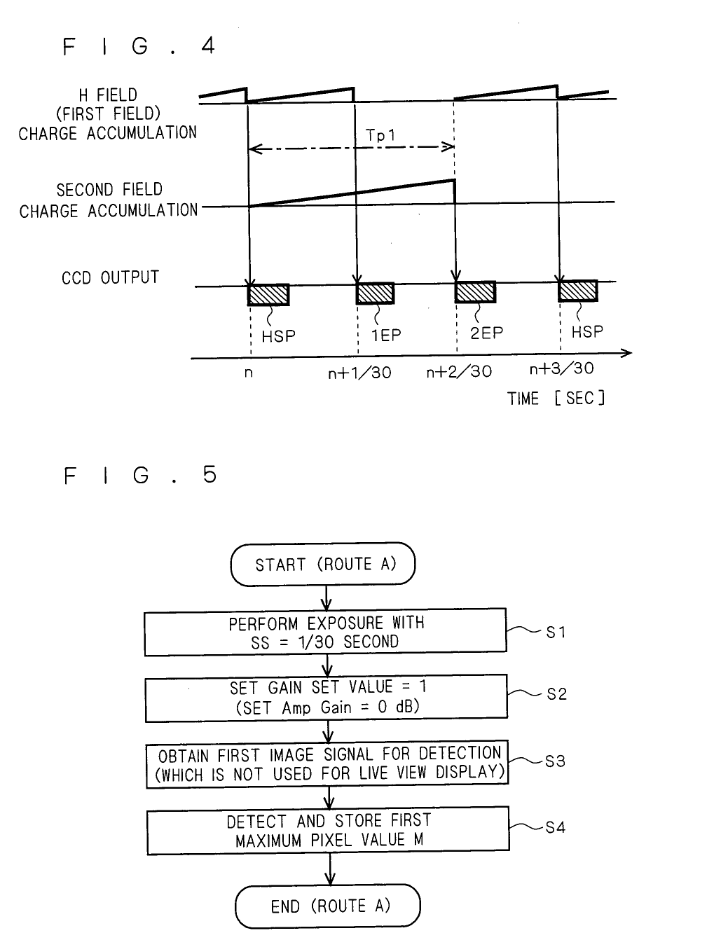

FIG. 2 is a diagram for describing a method of reading a charge signal of the CCD 4A in the high-speed reading mode and the reading mode for detection, and FIG. 3 is a diagram for describing the reading mode for detection. On the light-reception part 4a of the CCD 4A, millions of pixels are arranged in practice. FIGS. 2 and 3 show a part of the pixels for convenience. In each of FIGS. 2 and 3, two axes I and J which perpendicularly cross each other are indicated to clearly express a pixel position in the vertical and horizontal directions in the light-reception part 4a.

As shown in FIGS. 2 and 3, in the light-reception part 4a, a color filter array corresponding to the pixel array is provided. That is, the light-reception part 4a has the color filter array. The color filter array is constructed by three kinds of color filters of different colors of red (R), green (Gr, Gb) and blue (B) which are periodically distributed. In the following, the pixels on which the color filters of red (R), green (Gr, Gb) and blue (B) are arranged will be also referred to as an R pixel, a G pixel and a B pixel, respectively.

In the high-speed reading mode, for example, as shown in FIG. 2, charge signals of each of lines 2, 7, 10, . . . (H field) in the light-reception part 4a are read, thereby obtaining the analog image signal (hereinafter, referred to as “high-speed read image signal”) HSP. That is, the horizontal lines are read in a state where they are reduced to ¼. As shown in FIG. 2, the high-speed read image signal HSP includes all of color components of the color filter array, that is, signals of pixels of all of colors R, G and B on which all of the kinds of R, G and B color filters are arranged. The H field is a field having the same area as the first field in the reading mode for detection to be described below.

In the reading mode for detection, for example, as shown in FIGS. 2 and 3, reading is performed from different pixel groups (first and second reading), thereby obtaining two image signals 1EP and 2EP. That is, in the first and second reading, charge signals are read from fields (first and second fields) in the light-reception part 4a. In other words, the CCD 4A can read charge signals accumulated in the light-reception part 4a from a plurality of fields including the first (H) field and the second field obtained by dividing the pixel array of the light-reception part 4a.

Concretely, as shown in FIG. 2, like the high-speed reading mode, charge signals in each of lines 2, 7, 10, . . . (first field) in the light-reception part 4a are read, thereby obtaining an analog image signal (hereinafter, referred to as “first image signal for detection”) 1EP. As shown in FIG. 3, charge signals in each of lines 3, 8, 11, (second field) in the light-reception part 4a are read, thereby obtaining an analog image signal (hereinafter, referred to as “second image signal for detection”) 2EP. As shown in FIGS. 2 and 3, like the high-speed read image signal HSP, the first and second image signals 1EP and 2EP for detection include all of color components of the color filter array, that is, signals of pixels of all of R, G and B colors on which color filters of all of R, G and B are arranged.

In the CCD 4A, under control of the controller 10, in the image recording standby state, image signals are sequentially read in the high-speed reading mode and an image signal is read in the reading mode for detection at a predetermined timing (hereinafter, referred to as “detection timing”). In the preferred embodiment, after the state becomes the S1 state until the shutter button is depressed by the user and the state changes to the S2 state, image signals are read in the reading mode for detection at predetermined timings. Hereinafter, the detection timings will be described more.

FIG. 4 is a timing chart for describing timings of accumulating charges and reading charge signals in the CCD 4A. FIG. 4 shows a timing chart around detection timings. As “n” shown in FIG. 4, an arbitrary natural number or the like is applied. In order to prevent complication, FIG. 4 shows only a charge accumulation state corresponding to reading of charge signals from each field.

As shown in FIG. 4, in the image recording standby state, charge signals generated by exposure for 1/30 second are sequentially stored in the H field, the charge signals are read from the H field every 1/30 second, and the high-speed read image signal HSP is outputted from the CCD 4A.

At the detection timing, at the n-th second, charges are read from the H field and, by an operation of discharging the charge signals accumulated in the first and second fields or the like (hereinafter referred to as “vertical flow drain”), the charge signals accumulated in the first and second fields are discharged. By exposure (first exposure) for 1/30 second from the n-th second, charge signals are stored in the first field. Further, at the n+1/30 second, reading (first reading) of charge signals from the first field is performed and the first image signal 1EP for detection is outputted from the CCD 4A.

At the time of reading charge signals from the first field, charge signals are not discharged by the vertical flow drain but the charge signals are accumulated in the second field by exposure for 1/15 second (second exposure) from the n-th second. At the n+1/15 second, the charge signals are read from the second field (second reading), and the second image signal 2EP for detection is outputted from the CCD 4A.

That is, by reading the charge signals accumulated in the first field at the time of first exposure, the CCD 4A obtains the first image signal 1EP for detection. Further, by reading the charge signals accumulated in the second field at the first and second exposures, the second detection image signal 2EP is obtained. As a result, the CCD 4A obtains the first and second image signals 1EP and 2EP for detection with different exposure amounts. Therefore, the time of obtaining the first and second image signals 1EP and 2EP for detection can be shortened as compared with the case of separately performing exposure for 1/30 second and exposure for 1/15 second.

In charge accumulation time Tp1 (1/15 second) corresponding to the first and second exposures, charge accumulation for obtaining the high-speed read image signal HSP is not performed. That is, for example, at a timing of detecting the saturation voltage, a live view image is interrupted for 1/15 second. However, as compared with interruption of a live view image for 1/10 second in the case of separately performing exposure for 1/30 second and 1/15 second, interruption in display of the live view image can be shortened.

For example, in the image recording standby state, the controller 10 may control the time of the first and second exposures at the detection timings while opening the diaphragm 2 in accordance with the subject brightness value calculated by the AE/WB controller 18 on the basis of the high-speed read image signal HSP. With such a configuration, for example, when the subject brightness is high, the charge accumulation time Tp1 corresponding to the first and second exposures can be made shorter than 1/30 second. Thus, interruption in display of the live view image can be further shortened.

Detection of Saturation Voltage and Calculation and Setting of Minimum Gain Set Value in Normal Image Capturing

Detection of the saturation voltage and calculation and setting of the minimum gain set value in normal image capturing will be described later.

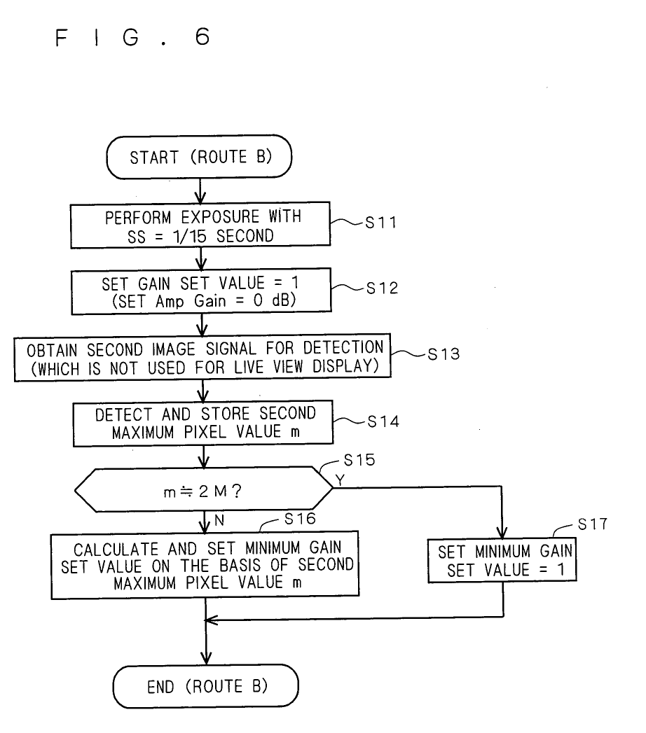

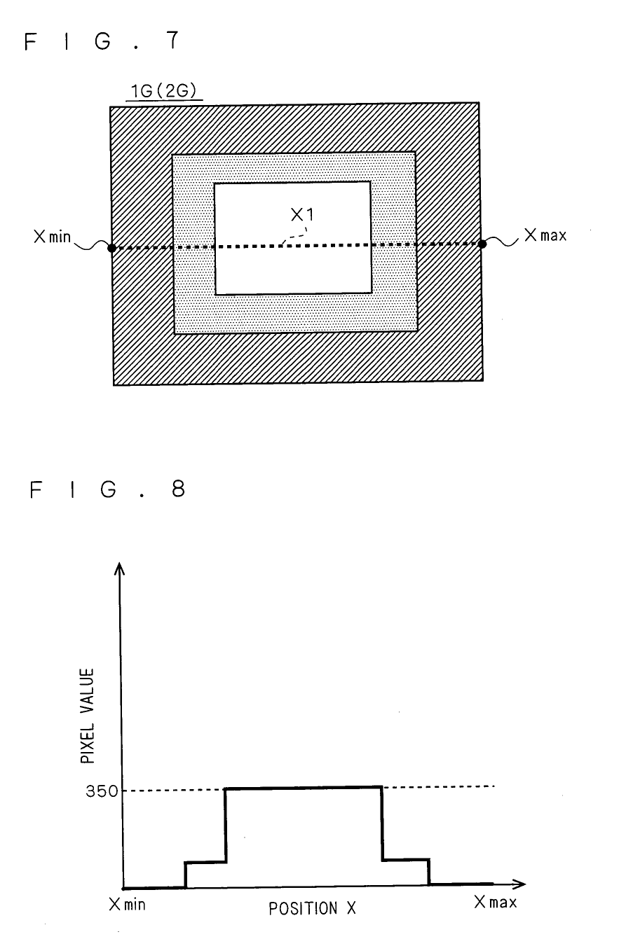

FIGS. 5 and 6 are flowcharts showing a flow of detecting the saturation voltage of the CCD 4A and calculating and setting the minimum gain set value. The detection of the saturation voltage and calculation and setting of the minimum gain set value are achieved by performing the operation flow (route A) shown in FIG. 5 and the operation flow (route B) shown in FIG. 6 in parallel. The operation flows shown in FIGS. 5 and 6 are controlled by the controller 10.

First, at the detection timing when the high S/N ratio priority mode is set in the normal image capturing, the operation flow of the route A starts and the program advances to step S1.

In step S1, exposure with the shutter speed value of, for example, 1/30 second is performed. After that, the program advances to step S2. As shown in FIG. 4, the charge signal is accumulated in the first field by exposure for 1/30 second. Under control of the AE/WB controller 18, for example, aperture value is controlled so that the maximum voltage of the charge signal accumulated in each of pixels in the CCD 4 becomes about 350 mV. Alternately, the maximum voltage of the charge signal accumulated in each of the pixels in the CCD 4A may be adjusted by the shutter speed value by opening the diaphragm to full open state.

In step S2, the gain set value is set to 1 (0 dB) and the program advances to step S3. In this case, the purpose is to detect the saturation voltage of the CCD 4A, so that it is controlled not to amplify the analog signal by the amplifier 6.

In step S3, the first image signal 1EP for detection is outputted from the CCD 4A at the timing as shown in FIG. 4. Via the AFE 60, the first image signal 1EP for detection converted to a digital signal is obtained. After that, the program advances to step S4. Since the gain set value is set to 1 in step S2, the first image signal 1EP for detection is converted to a digital signal without being amplified.

In step S4, on the basis of the detection image signal 1EP for detection obtained in step S3, the maximum value M of the brightness value (pixel value) of each pixel (hereinafter, referred to as “first maximum pixel value”) is detected by the saturation voltage detector 12 and stored into the storage 17, and the operation flow of the route A is finished. In step S4, for example, by detecting the maximum value of the pixel value of the G pixel with respect to the first image signal 1EP for detection, a first maximum pixel value M can be detected.

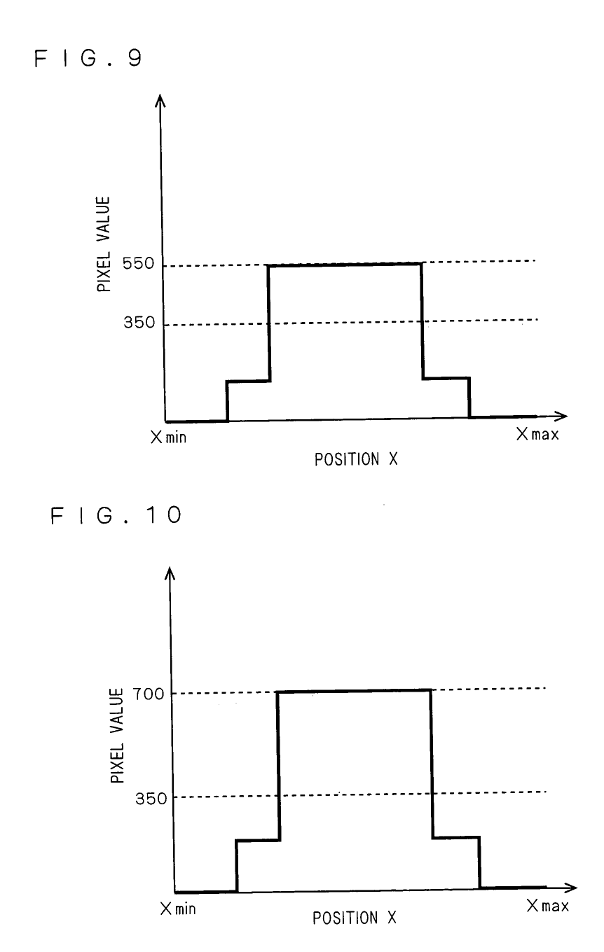

FIG. 7 is a diagram for describing the method of detecting the maximum value of the pixel value. FIG. 8 is a diagram for describing detection of the maximum value of the pixel value. For example, as shown in FIG. 7, the saturation voltage detector 12 can detect the first maximum pixel value M=350 as shown in FIG. 8, by recognizing the pixel value of the G pixel in a pixel line X1 in the horizontal direction in a center portion of an image 1G based on the first image signal 1EP for detection. Although the first maximum pixel value M is detected from the pixel value of the G pixel in the pixel line X1 in the center portion of the image 1G, the present invention is not limited to the case. For example, the first maximum pixel value M may be detected from the pixel value of the G pixels of the whole image 1G.

At the detection timing, with start of the operation flow of the route A, the operation flow of the route B also starts and the program advances to step S11.

In step S11, an exposure with a shutter speed value of, for example, 1/15 second is performed and the program advances to step S12. In this case, as shown in FIG. 4, the charge signal is accumulated in the second field by exposure for 1/15 second. In this case, under control of the AE/WB controller 18, a control is executed so that the f number is kept equal to that in step S2. In the case where the diaphragm is full open state and the maximum voltage of the charge signal is adjusted by the shutter speed, the shutter speed value is set to about twice as long as that in step S2.

In step S12, the gain set value is set to 1 (0 dB) and the program advances to step S13. In this case, the purpose is to detect the saturation voltage of the CCD 4A, so that it is controlled not to amplify the analog image signal by the amplifier 6.

In step S13, the second image signal 2EP for detection is outputted from the CCD 4A at a timing as shown in FIG. 4. Via the AFE 60, the second image signal 2EP for detection converted to a digital signal is obtained. After that, the program advances to step S14. Since the gain set value is set to 1 in step S12, the second image signal 2EP for detection is converted to a digital signal without being amplified.

In step S14, on the basis of the second image signal 2EP for detection obtained in step S13, the maximum value (hereinafter, referred to as “second maximum pixel value”) m of the pixel value is detected by the saturation voltage detector 12 and stored in the storage 17, and the program advances to step S15. In step S14, for example in a manner similar to the step S4, by detecting the maximum value of the pixel value of the G pixel with respect to the second image signal 2EP for detection, a second maximum pixel value m can be detected. Although the second maximum pixel value m is detected from the pixel value of the G pixel in the pixel line X1 in a center portion in the image 2G, the present invention is not limited to the method. The second maximum pixel value m may be detected from the pixel value of the G pixel of the whole image 2G.

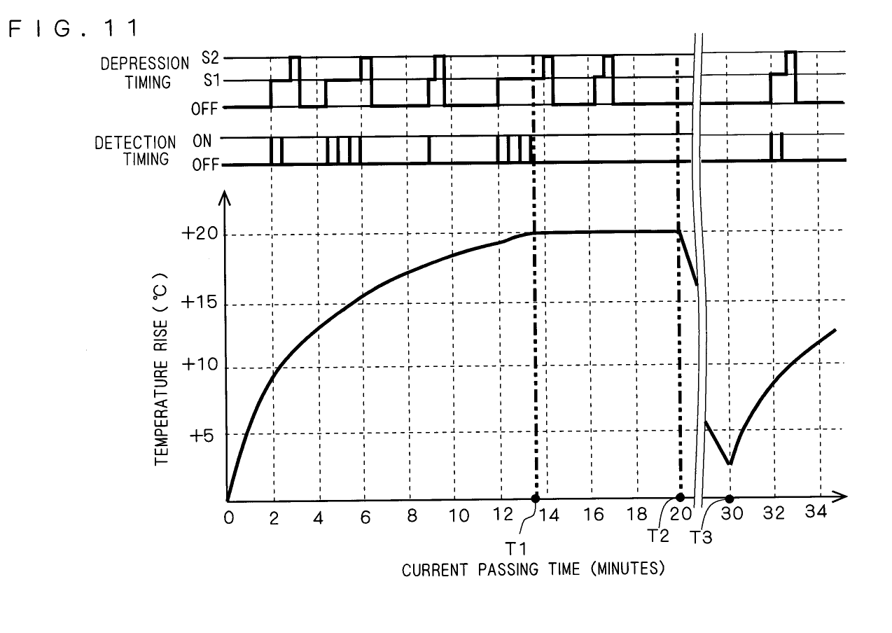

FIGS. 9 and 10 are diagrams for describing detection of the maximum value of the pixel value. For example, as shown in FIG. 7, in the saturation voltage detector 12, by recognizing the pixel value of the G pixel in the pixel line X1 in the horizontal direction in a center portion of an image G2 based on the second image signal 2EP for detection, the second maximum pixel value m can be detected as, for example, 550 or 700 as shown in FIGS. 9 and 10, respectively.

In step S15, the saturation voltage detector 12 determines whether or not the second maximum pixel value m stored in the storage 17 in step S14 is about twice as large as the first maximum pixel value M stored in the storage 17 in step S4 of the operation flow of the route A. If the second maximum pixel value m is not almost equal to “first maximum pixel value M×2”, the program advances to step 16. If the second maximum pixel value m is almost equal to “first maximum pixel value M×2”, the program advances to step S17.

Since the f number at the time of exposure of the shutter speed value=1/30 second in the route A and the f number at the time of exposure of the shutter speed value=1/15 second in the route B are equal, as long as the charge signal accumulated in the CCD 4A does not reach the saturation voltage, the second maximum pixel value m simply becomes about twice as large as the first maximum pixel value M. That is, if the second maximum pixel value m is almost the same as “first maximum pixel value M×2”, the charge signal accumulated in any of the pixels in the CCD 4A has not reach the saturation voltage, and the second maximum pixel value m is not a value corresponding to the saturation voltage of the CCD 4A. Concretely, when the first maximum pixel value M is detected as 350 as shown in FIG. 8 and the second maximum pixel value m is detected as 700 as shown in FIG. 10, the second maximum pixel value m is not a value corresponding to the saturation voltage of the CCD 4A and the saturation voltage detector 12 cannot detect the saturation voltage of the CCD 4A.

On the other hand, if the second maximum pixel value m is not almost the same as “first maximum pixel value M×2”, the charge signal accumulated in any of the pixels in the CCD 4A has reached the saturation voltage. At this time, the second maximum pixel value m is a value corresponding to the saturation voltage of the CCD 4A. Concretely, when the first maximum pixel value M is detected as 350 as shown in FIG. 8 and the second maximum pixel value m is detected as 550 as shown in FIG. 9, the second maximum pixel value m is a value corresponding to the saturation voltage of the CCD4A and the saturation voltage detector 12 can detect that the saturation voltage of the CCD 4A is 550 mV.

Therefore, the saturation voltage detector 12 detects the saturation voltage on the basis of the first and second image signals 1EP and 2EP for detection. That is, the saturation voltage is detected on the basis of two (generally, a plurality of) image signals obtained with different exposure amounts, so that the saturation voltage of the CCD 4A can be easily grasped.

In step S16, the controller 10 calculates the minimum gain set value on the basis of the second maximum pixel value m (saturation voltage) detected by the saturation voltage detector 12 in step S14 and finishes the operation flow of the route B. The minimum gain set value is calculated and set so as to be equal to “1023/second maximum pixel value m”.

In step S17, the minimum gain set value is set to 1 as a predetermined value. After that, the operation flow of the route B is finished. When it is assumed that the CCD 4A has the relation of the saturation voltage and the temperature shown in FIG. 26, it is difficult to consider that the saturation voltage of the CCD 4A becomes 700 mV or higher. Consequently, when the f number is controlled so that the first maximum pixel value M becomes about 350 in the operation flow of the route A, it is expected that the second maximum pixel value m becomes less than 700 in the operation flow of the route B and the relation of second maximum pixel value m<“first maximum pixel value M×2” is satisfied. However, there is a case such that due to various factors such as low brightness of the subject, the first maximum pixel value M does not become about 350 but becomes a relatively small value. In such a case, there is the possibility that the second maximum pixel value m is almost equal to “first maximum pixel value M×2”. In step S17, therefore, on assumption that the saturation voltage is relatively high, the minimum gain set value is set as 1.

At the time of generating a live view image in the image recording standby state, generally, the gain set value larger than 1 is set. However, in steps S2 and S12, the gain set value is set as 1 for the following reason. When the gain set value is set to a value larger than 1, in a case such that the first maximum pixel value M exceeds 512, the second maximum pixel value m becomes always 1023 and the saturation voltage of the CCD 4A cannot be accurately detected.

Therefore, before the detection timing, the gain set value is set to a value larger than 1 in order to generate a live view image. At the time of capturing the first and second image signals 1EP and 2EP for detection (at the detection timings), the gain set value is set as 1. In other words, the controller 10 controls the image capturing apparatus 100A so that the gain set value for the image signal for detecting the saturation voltage is smaller than that for the image signal for generating a live view image. As a result, the saturation voltage of the CCD 4A can be detected with reliability.

Timings of Detection of Saturation Voltage and Calculation and Setting of the Minimum Gain Set Value

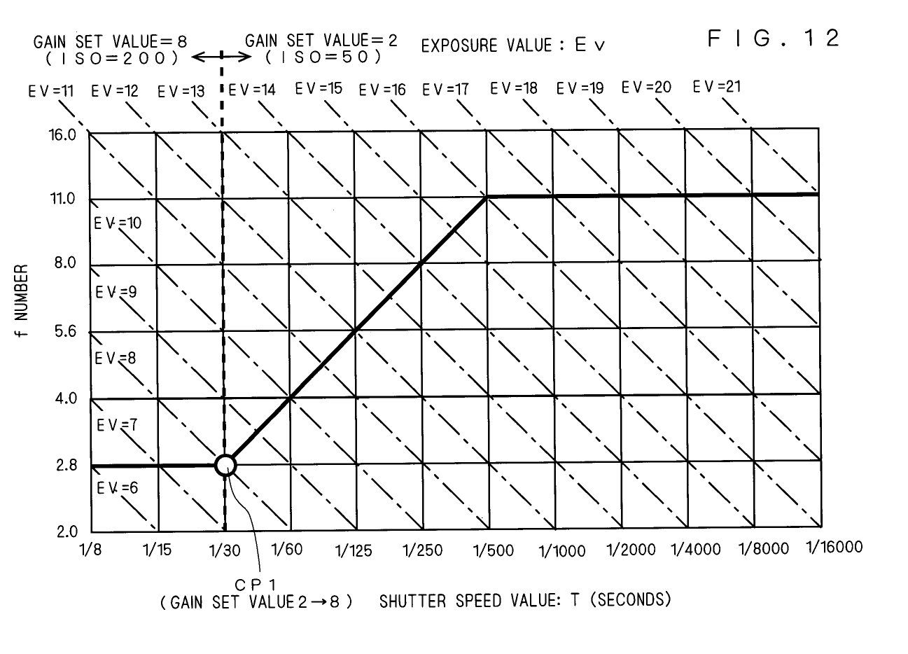

FIG. 11 is a timing chart showing timings of detection of the saturation voltage of the CCD 4A and calculation and setting of the minimum gain set value. FIG. 11 shows timings of depressing the shutter button (depression timings) and the saturation voltage detection timings. FIG. 11 also shows the relation between current passing time of the CCD 4A and temperature rise. In FIG. 11, the timings of detecting the saturation voltage are indicated as “ON”.

As shown in FIG. 11, in the image recording standby state, when the shutter button is depressed by the user and the S1 state is set, the operation of detecting the saturation voltage and calculating and setting the minimum gain set value, having the two operation flows shown in FIGS. 5 and 6 is performed once. To be specific, the saturation voltage detector 12 detects the saturation voltage in response to an instruction of starting the image recording preparing operation. As shown in FIG. 11, if the period of transition from the S1 state to the S2 state is long, the temperature of the CCD 4A rises during the period and the saturation voltage largely changes. Therefore, in the period of transition from the S1 state to the S2 state, under control of the controller 10, detection of the saturation voltage and calculation and setting of the minimum gain set value are repeated, for example, every 30 seconds, thereby dealing with a change in the saturation voltage. As a result, the saturation voltage of the CCD 4A is detected just before image capturing for recording, so that the gain set value (amplification factor) for the analog image signal can be optimized.

In this case, the saturation voltage detector 12 detects the saturation voltage at predetermined time intervals (intervals of about 30 seconds). As a result, unnecessary operation and process can be omitted as compared with the case of always detecting the saturation voltage, so that power can be saved.

As shown in FIG. 11, after lapse of predetermined time (T1=about 13.5 minutes in FIG. 11) since start of current passing of the CCD 4A, temperature rise of the CCD 4A is almost saturated and, after that, the temperature of the CCD 4A is maintained almost constant. Therefore, after start of current passing, when the saturation voltage of the CCD 4A becomes equal to or lower than the predetermined value, after that, the saturation voltage hardly decreases. As shown in FIG. 11, the saturation voltage detector 12 detects the saturation voltage of the CCD 4A until the saturation voltage becomes equal to or lower than the predetermined value (for example, 370 mV) under control of the controller 10. After the saturation voltage becomes equal to or lower than the predetermined value, as long as current passing of the CCD 4A continues (for example, current passing time=T1 to T2), detection of the saturation voltage of the CCD 4A is inhibited.

That is, after driving of the CCD 4A starts and the saturation voltage becomes equal to or lower than the predetermined value, the saturation voltage detector 12 does not detect the saturation voltage until driving of the CCD 4A is restarted after interruption. As a result, useless operation of detecting the saturation voltage and calculating and setting the minimum gain set value can be omitted, so that the power consumption can be reduced.

As shown in FIG. 11, for example, in the case where the current passing of the CCD 4A is finished once after lapse of T2=20 minutes since start of current passing and, after lapse of T3=30 minutes since start of the first current passing, the current passing of the CCD 4A is re-started, under control of the controller 10, the saturation voltage detector 12 detects the saturation voltage until the saturation voltage becomes equal to or lower than the predetermined value.

AE in High S/N Ratio Priority Mode

As described above, in the high S/N ratio priority mode, the AE/WB controller 18 obtains the minimum gain set value on the basis of the saturation voltage. From the program chart according to the minimum gain set value, the AE control value is obtained. A concrete example will be described later.

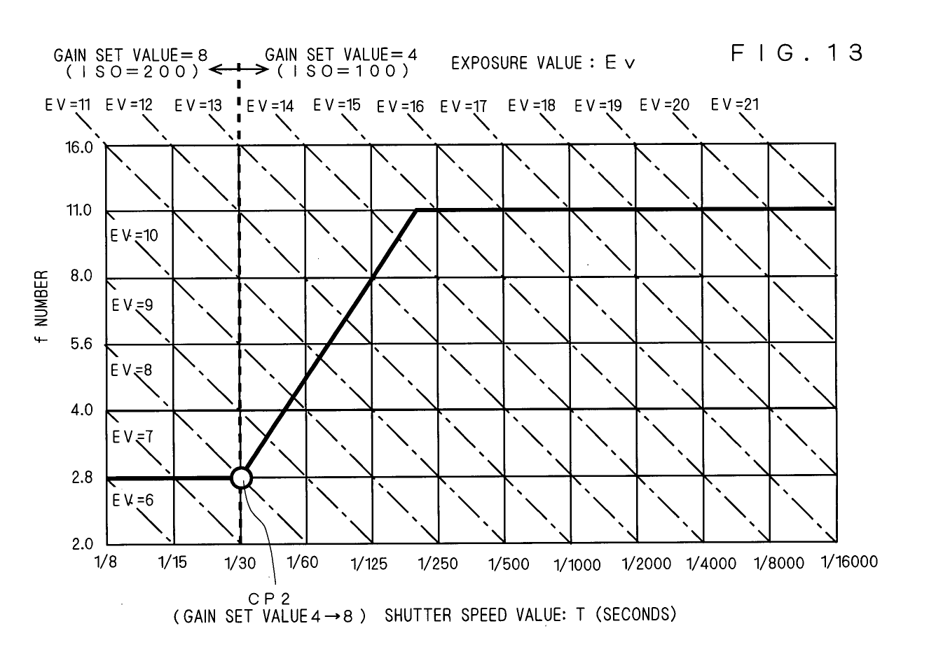

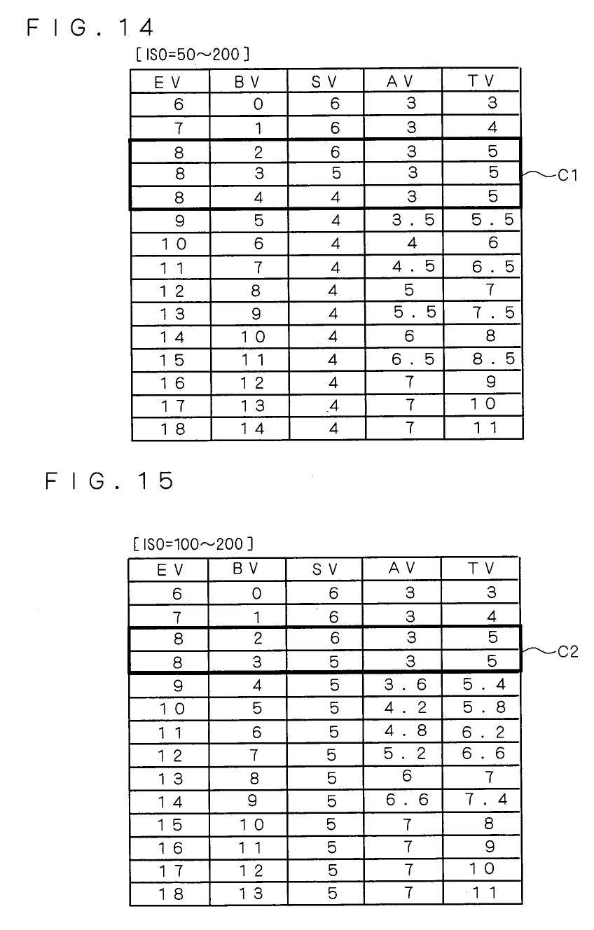

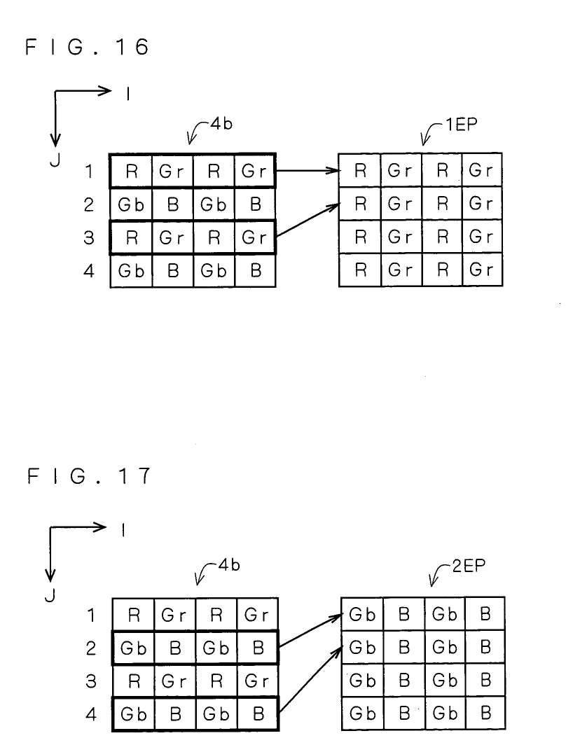

FIGS. 12 and 13 are program charts illustrating the relation between the subject brightness and the AE control value. FIGS. 14 and 15 are diagrams for describing setting of the gain set value, in which image blurring caused by a camera shake is considered. Each of FIGS. 14 and 15 is a table showing, by APEX values which will be described later, the relation between the subject brightness and the AE control value shown in FIGS. 12 and 13.

In FIGS. 12 to 15, as necessary, the brightness of the subject, AE control value, and the like are converted to APEX values (aperture value AV, time value TV, brightness value BV, speed value SV and exposure value EV).

FIGS. 12 and 13 show the relations among exposure value EV, the AE control values (f number, shutter speed value T and a gain set value). It is assumed that in the image capturing apparatus 100A, the f number is changeably set in a range from f=2.8 to f=11.0 and the gain set value is changeably set in a range from 2 to 8. It is also assumed that the relation of the following expression (1) is satisfied between ISO sensitivity (S) and the gain set value.

S=25 ×(gain set value) (1)

Further, the AE/WB controller 18 converts focal length F of the taking lens 1 into focal length F′ in the case of a 35 mm film, and performs AE in consideration of prevention of a blur of a captured image caused by a camera shake in accordance with the focal length F′.

FIGS. 12 to 15 will be described later.

FIGS. 12 and 13 are program charts of the case where the minimum gain set value is set to 2 and 4, respectively. The saturation voltage in the case shown in FIG. 13 is relatively lower than that in the case shown in FIG. 12, and a situation in which the minimum gain set value has to be increased is shown in FIG. 13.

For example, in the program chart of FIG. 12, in the case where the shutter speed value is 1/30 (=1/F′) second or less, a blur in a captured image caused by a camera shake does not easily occur, so that the gain set value is fixed to 2 as the minimum value and the f number and the shutter speed value are changed according to a change in the subject brightness (brightness value BV). On the other hand, in the case where the shutter speed value is larger than 1/30 (=1/F′) second, a blur in a captured image due to a camera shake easily occurs, so that the shutter speed value is suppressed not to increase from 1/30 second as much as possible. The gain set value is controlled to increase as the subject brightness decreases, thereby correcting insufficient exposure. Concretely, at a point CP1 in the program chart, the gain set value is changed in the range from 2 to 8 (the speed value SV from 4 to 6) in accordance with decrease in the subject brightness. Specifically, as shown by a portion in the thick frame C1 in FIG. 14, in correspondence with decrease in the brightness value BV from 4 to 2, the speed value SV is changed from 4 to 6.

In the program chart shown in FIG. 13, like the program chart shown in FIG. 12, when the shutter speed is 1/30 (=1/F′) second or less, a blur caused by a camera shake does not easily occur in a captured image. Consequently, the gain set value is fixed at 4 as the minimum value, and the f number and the shutter speed value are changed according to a change in the subject brightness (brightness value BV). On the other hand, when the shutter speed is longer than 1/30 (=1/F′) second, a blur tends to occur in a captured image due to a camera shake. Consequently, the shutter speed value is suppressed not to increase from 1/30 second as much as possible. As the subject brightness decreases, the gain set value is controlled so as to increase, thereby correcting insufficient exposure. Concretely, at a point CP2 in the program chart, the gain set vale is changed in the range from 4 to 8 (the sensitivity value SV is changed from 5 to 6) as the subject brightness decreases. Specifically, as shown in a portion in the thick frame C2 in FIG. 15, in correspondence with decrease in the brightness value BV from 3 to 2, the speed value SV is changed from 5 to 6.

Therefore, when the gain set value is held at a predetermined value (2 or 4), as the subject brightness decreases, the shutter speed value is set to a value larger than a predetermined threshold (1/F′) regarding occurrence of a camera shake. In such a case, the AE/WB controller 18 performs control to increase the gain set value so that the shutter speed value is not set to a value larger than the predetermined threshold (1/F′) as much as possible. As a result, even in the case where the subject brightness is low to a certain degree, deterioration in picture quality caused by a camera shake can be suppressed.

In the case where exposure insufficiency is not solved by setting the gain set value to 8 (by setting the sensitivity value SV to 6) on the basis of the program chart of FIG. 12 or 13, the AE/WB controller 18 controls the image capturing apparatus 100A so as to further increase the shutter speed value in spite of increase in a chance of occurrence of a blur in a captured image due to a camera shake.

As described above, in the image capturing apparatus 100A according to the first preferred embodiment, the saturation voltage of the CCD 4A is detected immediately before image capturing for image recording and, according to the detected saturation voltage, amplification of the analog image signal by the amplifier 6 is controlled. As a result, without directly measuring the temperature of the CCD 4A, the performance (dynamic range) of the CCD 4A can be sufficiently utilized and an image of excellent picture quality with a high S/N ratio can be obtained. It does not increase the size of the circuit and apparatus.

Second Preferred Embodiment

In the first preferred embodiment,.as shown in FIGS. 2 and 3, charge signals (high-speed read image signal HSP and first image signal 1EP for detection) are read from similar fields (H and the first field) in the light-reception part 4a in the high-speed reading mode and the first reading operation. In the first and second reading operations, charge signals (first and second image signals 1EP and 2EP for detection) are read from different fields (the first and second fields) which do not overlap with each other in the light-reception part 4a.

For the image capturing device in a conventional image capturing apparatus, a method of dividing a light-reception part into a plurality of fields and reading image signals of all of pixels on a field unit basis is employed. At present, a type of dividing one frame into two fields and reading all of pixels (hereinafter, referred to as “2-field reading type”) is generally used. A method of reading a charge signal in the image capturing device of a general 2-field reading type and that in the CCD 4A of the image capturing apparatus 100A according to the first preferred embodiment are different from each other.

In an image capturing apparatus 100B according to a second preferred embodiment, a CCD 4B of the 2-field reading type is used as the CCD. A light-reception part 4b of the CCD 4B has a structure similar to that of the light-reception part 4a. The way of reading charge signals, charge storing timing, and charge signal reading timing in the CCD 4B are different from those in the CCD 4A. Since the other parts of the image capturing apparatus 100B are similar to those of the image capturing apparatus 100A, similar reference numerals are given and their description will not be repeated.

The CCD 4B has, like the CCD 4A, as modes of reading a charge signal as an image signal, three reading modes of an image capturing mode, a high-speed reading mode, and a reading mode for detection.

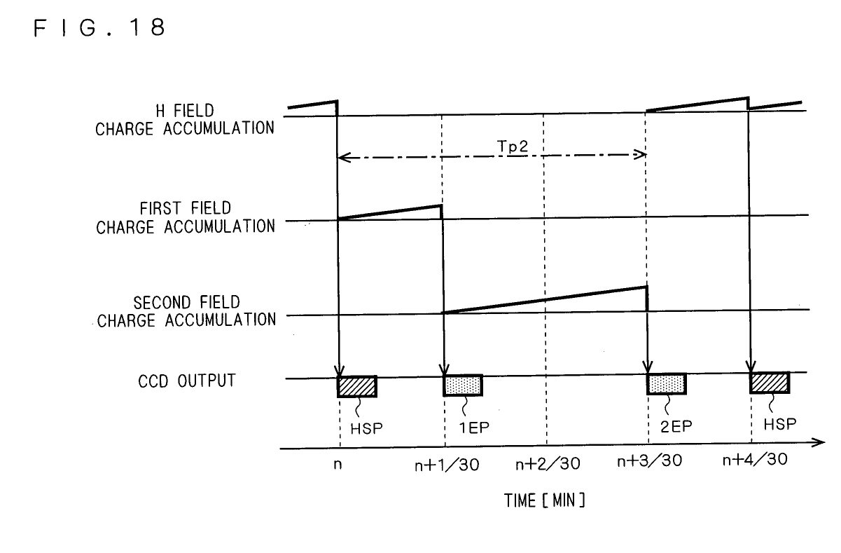

FIGS. 16 and 17 are diagrams for describing a reading method in the reading mode for detection. In the CCD 4B, for example, as shown in FIG. 16, charge signals in lines (first field) 1, 3, . . . , and 2j-1 (j: a natural number of 3 or larger) in the light-reception part 4b are read, thereby obtaining the first image signal 1EP for detection. As shown in FIG. 17, charge signals in lines 2, 4, . . . , and 2j (second field) are read in the light-reception part 4b, thereby obtaining a second image signal 2EP for detection. Since the method of reading charge signals from the H field in the high-speed reading mode is similar to the reading method shown in FIG. 2, its description will not be repeated.

FIG. 18 is a timing chart for describing storing and reading of charges in/from the CCD 4B. FIG. 18 shows the timing chart around a detection timing. Since some pixels in the H field and the first field are overlapped with each other and some pixels in the H field and the second field are overlapped with each other, it is difficult to strictly show a charge storage state of each field. Consequently, only the charge storage state corresponding to reading of charge signals from each field is shown in FIG. 18 for convenience. As “n” in FIG. 18, an arbitrary natural number or the like can be applied.

For example, as shown in FIG. 18, in the image recording standby state, the H fields are sequentially exposed for 1/30 second and charge signals are stored, the charge signals are read from the H fields every 1/30 second (reading in the high-speed reading mode), and the high-speed read image signal HSP is outputted from the CCD 4B.

At a detection timing, the reading of the charge signals from the H fields is temporarily interrupted and the charge signals are stored in the first fields by exposure of 1/30 second (first exposure) from the n-th second. At the (n+1/30)th second, the charge signal is read from the first field (first reading), and the first image signal 1EP for detection is outputted from the CCD 4B.

By exposure of 1/15 second (second exposure) from the (n+1/30)th second, the charge signal is stored in the second field. The charge signal is read from the second field at (n+1/10)th second (second reading), and the second image signal 2EP for detection is outputted from the CCD 4B.

In charge accumulation time Tp2 (1/10 second) corresponding to reading of charge signals from the first and second fields, charge accumulation for obtaining the high-speed read image signal HSP is not performed. Specifically, at the timing of detecting the saturation voltage, a live view image is interrupted for 1/10 second. However, by applying the existing CCD of the 2-field reading type, the first and second image signals 1EP and 2EP for detection can be easily obtained.

In this case, therefore, the CCD 4B is subjected to the first exposure and, after that, the CCD 4B is subjected to the second exposure of exposure time different from the exposure time of the first exposure. By reading a charge signal stored in the light-reception part 4b at the time of the first exposure, the first image signal 1EP for detection is obtained. By reading a charge signal stored in the light-reception part 4b at the time of the second exposure, the second image signal 2EP for detection is obtained. As a result, by exposures of twice of different exposure time (generally, a plurality of times), two (generally, a plurality of) image signals of different exposure amounts are obtained. Thus, the saturation voltage of the CCD 4B can be easily grasped.

Third Preferred Embodiment

In the image capturing apparatuses 100A and 100B according to the first and second preferred embodiments, the saturation voltage is detected from the pixel value corresponding to each of the pixels in the CCDs 4A and 4B. However, as described above, according to designing of an image capturing device or manufacturing conditions, there is a case such that the maximum voltage (transfer path saturation voltage) of a charge signal which can be transferred through a charge transfer path (vertical CCD, horizontal CCD or the like) is smaller than the saturation voltage of a pixel (pixel saturation voltage). Also in such a case, the transfer path saturation voltage can be detected from a pixel value. When the subject is very dark, there is a case such that it is difficult for the voltage of a charge signal accumulated in each pixel to reach the transfer path saturation voltage. In such a case, the transfer path saturation voltage (saturation voltage) cannot be detected from each pixel value.

In an image capturing apparatus 100C according to a third preferred embodiment, at the time of reading a charge signal accumulated in each pixel at a detection timing, charge signals accumulated in a plurality of pixels are added (mixed). As a result, the voltage of the charge signal transferred through the charge transfer path is increased to the transfer path saturation voltage and the saturation voltage of the CCD 4A is detected. Therefore, the image capturing apparatus 100C is different from the image capturing apparatuses 100A and 100B with respect to only the point that the first and second image signals 1EP and 2EP for detection are obtained while mixing the charge signals accumulated on a plurality of pixels. In the image capturing apparatus 100C according to the third preferred embodiment, therefore, a CCD 4C is used as the CCD and a light-reception part 4c of the CCD 4C has a structure similar to that of the light-reception part 4a. Since the other points are similar to those of the image capturing apparatuses 100A and 100B, similar reference numerals are designated and description will not be repeated.

In the CCD 4C, in a manner similar to the case of the CCDs 4A and 4B shown in FIGS. 2, 3, 16 and 17, by reading charge signals from the first and second fields, the first image signals 1EP and 2EP for detection are outputted. In the CCD 4C, at the time of reading the charge signals from the first and second fields, for example, charge signals accumulated in G pixels neighboring each other in the vertical direction (J direction) are mixed (added).

FIG. 19 is a diagram for describing mixture of charge signals in the CCD 4C. FIG. 19 shows, as an example, mixture of charge signals in an image capturing device of the 2-field reading type such as the CCD 4B shown in FIGS. 16 and 17. In FIG. 19, attention is paid to one line VL of pixels arranged in the vertical direction (J direction) (vertical pixel line) around the light-reception part 4c of the CCD 4C.

As shown in FIG. 19, the CCD 4C has a vertical transfer path (vertical CCD) VC for reading charge signals from pixels in the vertical pixel line VL. For example, at the time of reading charge signals from lines (second field) 2, 4, . . . , and 2j (j: natural number of 3 or larger) in the light-reception part 4c , charge signals in the G pixels neighboring each other in the J direction are added (mixed) in the vertical transfer path VC. Although an example of adding charge signals of two pixels is shown here, charge signals of three or more pixels may be added.

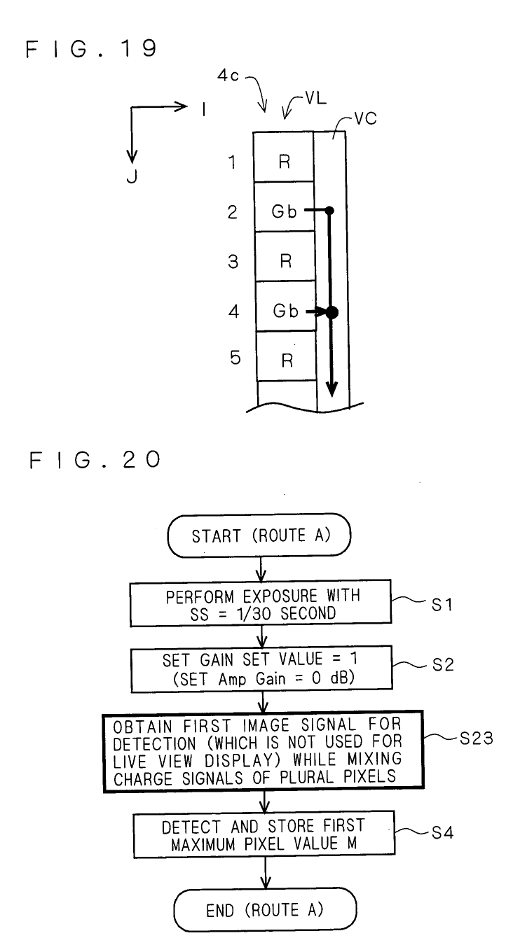

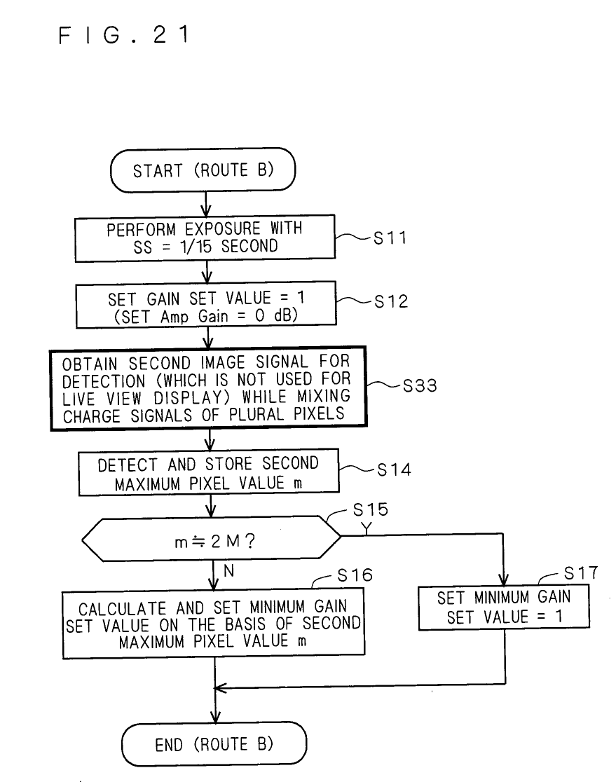

FIGS. 20 and 21 show flowcharts of the flow of detecting the saturation voltage of the CCD 4C and calculating and setting the minimum gain set value. The flowcharts of FIGS. 20 and 21 are similar to those of FIGS. 5 and 6 except that steps S3 and S13 are replaced with steps S23 and S33, respectively. Similar steps are designated with similar numerals and their description will not be repeated.

in step S23, at timings as shown in FIGS. 4 and 18, while mixing charge signals of a plurality of pixels in the CCD 4C, the first image signal 1EP for detection is outputted, the first image signal 1EP for detection converted as a digital signal is obtained via the AFE 60, and the program advances to step S4. Since the gain set value is set to 1 in step S2, the first image signal 1EP for detection is converted to a digital signal without being amplified.

In step S33, at timings as shown in FIGS. 4 and 18, the second image signal 2EP for detection is outputted by the CCD 4C while charge signals of a plurality of pixels are mixed, the second image signal 2EP for detection converted to a digital signal via the AFE 60 is obtained, and the program advances to step S14. Since the gain set value is set to 1 in step S12, the second image signal 2EP for detection is converted to a digital signal without being amplified.

As described above, in the image capturing apparatus 100C according to the third preferred embodiment, charge signals of a plurality of pixels in the vertical transfer path VC or the like are added. That is, by adding charge signals (output signals) outputted from a plurality of pixels included in the light-reception part 4a, the CCD 4C obtains the first and second image signals 1EP and 2EP for detection. As a result, even in the case where the subject brightness is low, the transfer path saturation voltage of the CCD 4C can be detected.

Fourth Preferred Embodiment

In the image capturing apparatuses 100A and 100C according to the first and third preferred embodiments, with respect to normal image capturing which does not accompany the light emitting operation of the electronic flash device 50, the saturation voltage of the CCDs 4A and 4C is detected and the minimum gain set value is set. In contrast, in an image capturing apparatus 100D according to the fourth preferred embodiment, in image capturing with flash, the saturation voltage of a CCD 4D is detected and the minimum gain set value is set. A light-reception part 4d of the CCD 4D has a structure similar to that of each of the light-reception parts 4a and 4c. The image capturing apparatus 100D according to the fourth preferred embodiment is similar to each of the image capturing apparatuses 100A and 100C according to the first and third preferred embodiments except for the light emitting operation of the electronic flash device 50, and the other operation and parts are similar. Consequently, the same reference numerals are designated and the description will not be repeated.

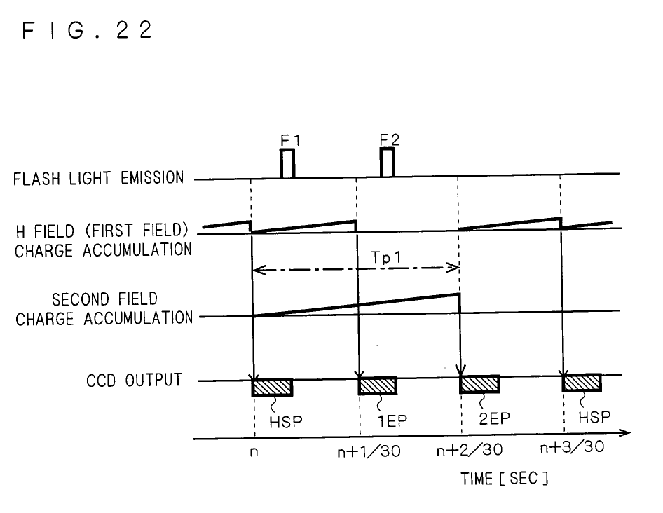

FIG. 22 shows a timing chart of timings of storing and reading charges to/from the CCD 4D and emitting flash light. The timing chart shown in FIG. 22 is obtained by adding the timings of emitting flash light to the timing chart of FIG. 4.

As shown in FIG. 22, at a detection timing, a charge is read from the H field and the operation of discharging the charge signal (vertical flow drain) is performed at the n-th second, thereby discharging the charge signals accumulated in the first and second fields and the like. For the period from the n-th second to the (n+1/30)th second, charge signals are accumulated in the first field by an exposure (first exposure) of 1/30 second including the first light emission F1. Further, at the (n+1/30)th second, the charge signal is read from the first field (first reading operation), and the first image signal 1EP for detection is outputted from the CCD 4D.

At the time of reading the charge signal from the first field, the charge signal is not discharged by the vertical flow drain but the electronic flash device 50 performs second light emission F2 with the same light emission amount as that of the first light emission F1 during the period from the (n+1/30)th second to the (n+1/15)th second. By the exposure (second exposure) for 1/15 second of the period from the n-th second to the (n+1/15)th second including the first and second light emissions F1 and F2 of the same light emission amount from the electronic flash device 50, the charge signals are stored in the second field. Further, the charge signals are read from the second field at the (n+1/15)th second (second reading operation), and the second image signal 2EP for detection is outputted from the CCD 4D.

That is, the CCD 4D can read the charge signals accumulated in the light-reception part 4d from each of a plurality of fields including the first and second fields obtained by dividing the pixel array of the light-reception part 4d. The electronic flash device 50 performs the second light emission F2 after the first light emission F1. At this time, the CCD 4D reads out the charge signals accumulated in the first field in the first exposure time including the period in which the first light emission F1 is performed, thereby obtaining the first image signal 1EP for detection. The CCD 4D reads out the charge signals accumulated in the second field in the second exposure time including the period of the first light emission F1 is performed and the period in which the second light emission F2 is performed, thereby obtaining the second detection image signal 2EP. As a result, as compared with the case of performing the first and second exposures separately, the time required to obtain the first and second image signals 1EP and 2EP for detection can be shortened, and a live view image can be smoothly displayed with lesser interruption.

Also in image capturing with flash, in a manner similar to the normal image capturing, when the normal mode is set, the predetermined minimum gain set value Gₘᵢₙ corresponding to the minimum value Dₘᵢₙ of saturation voltage of the CCD 4D expected in association with rise in temperature is set.

On the other hand, when the high S/N ratio priority mode is set, in a manner similar to the normal image capturing, the minimum gain set value according to the saturation voltage of the CCD 4D is set. Therefore, when the high S/N ratio priority mode is set, if the saturation voltage of the CCD 4D is larger than the predetermined minimum value Dₘᵢₙ, by setting the gain set value to a value smaller than the predetermined gain set value Gₘᵢₙ to increase a light emission amount, it is controlled so as to compensate the reduction amount of the gain set value. As a result, although sensitivity deteriorates due to decrease in the gain set value, a captured image having a high S/N ratio and good picture quality can be obtained.

The light emission amount of the electronic flash device 50 is limited according to its performance like any other electronic flash devices. Consequently, in the case where the exposure amount (light emission amount) is insufficient even when the electronic flash device 50 emits light of the maximum light emission amount, by changing the gain set value so as to be increased, the insufficient amount of the exposure amount (light emission amount) is compensated. As a result, by having balance between the performance of the electronic flash device 50, that is, an insufficient light emission amount and the S/N ratio, a captured image having good picture quality can be obtained.

As described above, in the image capturing apparatus 100D according to the fourth preferred embodiment, the CCD 4D obtains the first and second image signals 1EP and 2EP for detection by using different exposure amounts in accordance with the light emitting operation of the electronic flash device 50. Also in image capturing with flash, the saturation voltage of the CCD 4D is detected in a real-time manner immediately before image capturing for image recording. As a result, without directly measuring the temperature of the CCD 4D, the performance (dynamic range) of the CCD 4D is fully utilized and an image having a high S/N ratio and good picture quality can be obtained.

Fifth Preferred Embodiment

In the image capturing apparatuses 100B and 100C according to the second and third preferred embodiments, for normal image capturing which does not accompany the light emitting operation of the electronic flash device 50, the saturation voltage of the CCDs 4B and 4C is detected, and the minimum gain set value is set. In contrast, in an image capturing apparatus 100E according to a fifth preferred embodiment, in image capturing with flash, the saturation voltage of the CCD 4E is detected and the minimum gain set value is set. A light-reception part 4e of the CCD 4E has a structure almost the same as each of the light-reception parts 4b and 4c. The image capturing apparatus 100E according to the fifth preferred embodiment accompanies only the light emitting operation of the electronic flash device 50. Since the other operations and parts are similar to those of the image capturing apparatuses 100B and 100C according to the second and third preferred embodiments, the same reference numerals are designated and the description will not be repeated.

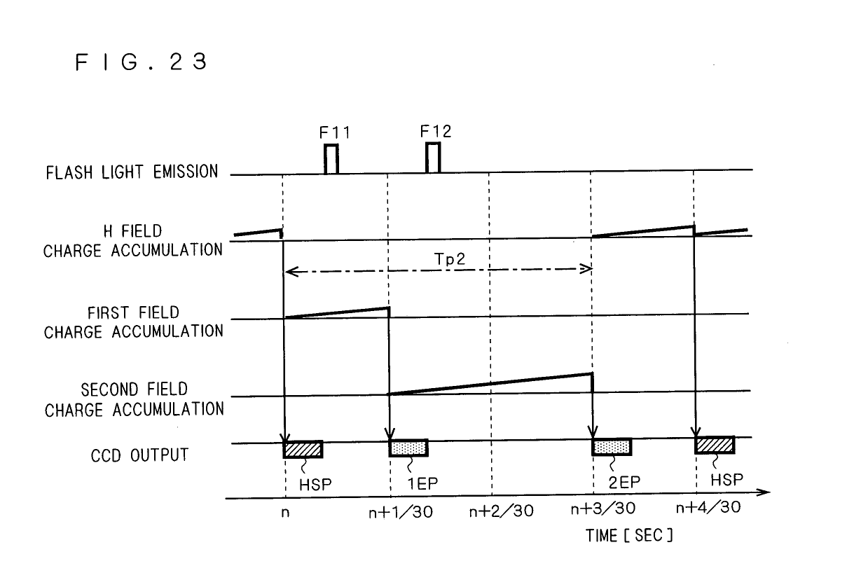

FIG. 23 is a timing chart for illustrating timings of charge accumulation and reading of the CCD 4E and flash light emission. The timing chart of FIG. 23 is obtained by adding the timings of flash light emission to the timing chart of FIG. 18.

As shown in FIG. 23, at a detection timing, reading of a charge signal from an H field is temporarily interrupted, and a charge signal is accumulated in the first field by exposure of 1/30 second (first exposure) including first light emission F11 during the period from the n-th second to the (n+1/30)th second. At the (n+1/30)th second, the charge signal is read from the first field (first reading), and the first detection image signal 1EP for detection is outputted from the CCD 4E.

During the period from the (n+1/30)th second to the (n+1/10)th second, a charge signal is accumulated in the second field by exposure of 1/15 second (second exposure) including second light emission F12 of a light emission amount which is twice as large as the light emission amount of the first light emission F11. At the (n+1/10)th second, the charge signal is read from the second field (second reading), and the second image signal 2EP for detection is outputted from the CCD 4E.

In other words, the electronic flash device 50 performs the first light emission F11 and, after that, the second light emission F12 of the light emission amount different from that of the first light emission F11. The CCD 4E reads the charge signal accumulated in the light-reception part 4e at the time of the first light emission F11, thereby obtaining the first image signal 1EP for detection. By reading the charge signal accumulated in the light-reception part 4e at the time of the second light emission F12, the second image signal 2EP for detection is obtained. Therefore, with the light emissions F11 and F12 of twice of different light emission amounts, two image signals 1EP and 2EP of the different exposure amounts are obtained. As a result, the saturation voltage of the CCD 4E can be easily grasped.

As described above, in the image capturing apparatus 100E according to the fifth preferred embodiment, the CCD 4E sets different exposure amounts according to the light emitting operations of the electronic flash device 50 and obtains the first and second image signals 1EP and 2EP for detection. As a result, without directly measuring the temperature of the CCD 4E, by fully utilizing the performance (dynamic range) of the CCD 4E, an image having a high S/N ratio and good picture quality can be obtained.

Modifications

Although the preferred embodiments of the present invention have been described above, the present invention is not limited to the foregoing preferred embodiments.

For example, in the image capturing apparatus 100C according to the third preferred embodiment, the charge signals of a plurality of pixels are added in the vertical transfer path VC and the charge signals are sequentially read from the first and second fields, thereby obtaining the first and second image signals 1EP and 2EP for detection. The present invention is not limited to the preferred embodiment. For example, without reading the charge signals from the first field at the detection timings at the time of reading the charge signals from the second field, the charge signals of the plurality of pixels are discriminated as a charge signal which is not added and a charge signal which is added in the vertical transfer path VC, and the discriminated charge signals can be obtained as the first and second image signals 1EP and 2EP for detection. That is, by reading the charge signal once, the first and second image signals 1EP and 2EP for detection are obtained simultaneously.

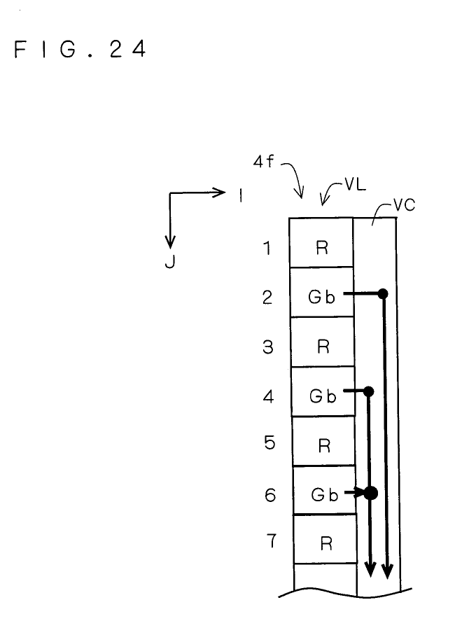

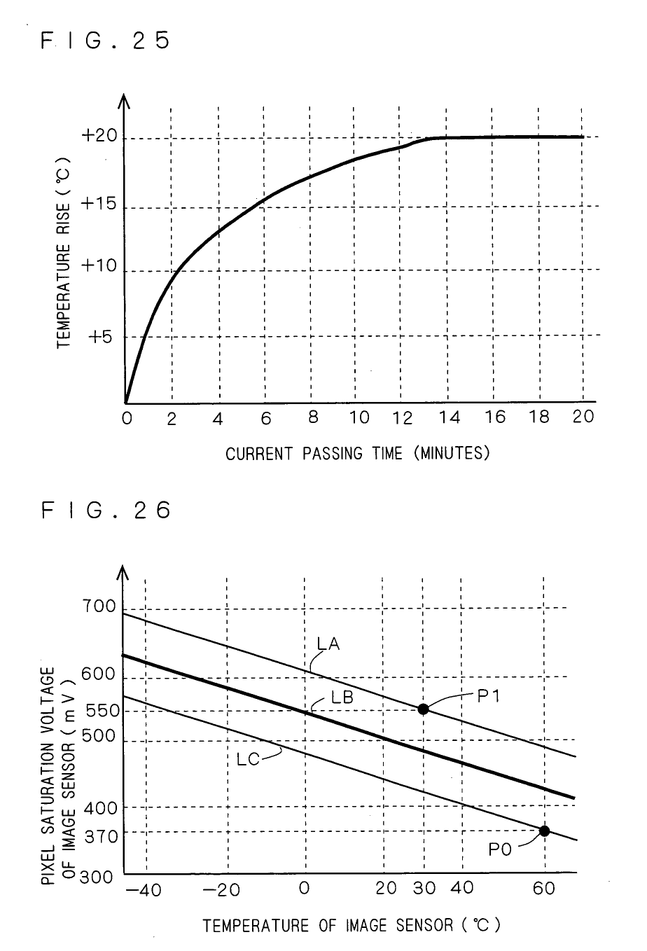

FIG. 24 is a diagram for describing reading of the charge signal in a CCD 4F according to a modification of the third embodiment. FIG. 24 shows an example of reading of the charge signals in a 2-field reading type image capturing device like the CCD 4B shown in FIGS. 16 and 17. In FIG. 24, attention is paid to one pixel column (vertical pixel line) VL of pixels lined in the vertical direction (J direction) around a light-reception part 4f of the CCD 4F. The light-reception part 4f of the CCD 4F has a structure similar to that of the light-reception part 4b or the like.

As shown in FIG. 24, the CCD 4F has a vertical transfer path (vertical CCD) VC to read charge signals from the pixels in the vertical pixel line VL. For example, at the time of reading charge signals from lines (second field) of 2, 4, . . . , and 2j (j: natural number of 3 or larger) in the light-reception part 4f, without adding charge signals of the G pixel adjacent to each of lines 6k-4 (k: natural number) in the vertical direction (J direction) in the vertical transfer path VC, the first image signal 1EP for detection is obtained. By adding charge signals of the G pixels (G pixels in the 6k-2 and 6k lines) adjacent to the lines 6k-2 and 6k in the vertical direction (J direction) in the vertical transfer path VC, the second image signal 2EP for detection is obtained. Although the charge signals of two pixels are added in this example, charge signals of three or more pixels may be added.

At the time of reading the charge signal from a field (second field), the saturation voltage detector 12 obtains the first image signal 1EP for detection without adding charge signals outputted from a plurality of G pixels in the vertical transfer path VC, and obtains the second image signal 2EP for detection by adding the charge signals from the plurality of other G pixels by the vertical transfer path VC. As a result, the saturation voltage of the vertical transfer path VC of the CCD 4F can be grasped by a single exposure, so that exposure time necessary to detect the saturation voltage can be shortened.

In the foregoing preferred embodiments, at the time of obtaining the first and second image signals 1EP and 2EP for detection, the exposure time is set to 1/30 second and 1/15 second, respectively. The present invention is not limited to the values. For example, in a case such that the brightness of a subject is low, the exposure time may be extended. As a result, even in the case where the brightness of a subject is low, the saturation voltage of the image capturing device can be detected with reliability. On the other hand, in a case such that the brightness of a subject is high, the exposure time may be shortened. As a result, an influence on a live view image, such as a dropout of a live view image can be suppressed.

In the foregoing preferred embodiments, in step S17 shown in FIG. 6, the minimum gain set value is set to 1 as a predetermined value. The present invention is not limited to the value. For example, the predetermined value may be variously changed on the basis of the operation of the user.

Although the saturation voltage is detected on the basis of the pixel value corresponding to the G pixel in the foregoing preferred embodiments, the present invention is not limited to the case. For example, when the white balance is extremely lost, the saturation voltage may be detected on the basis of the pixel values corresponding to pixels of all of R, G and B.

In the foregoing preferred embodiments, the first image signal 1EP for detection is obtained by reading charge signals from all of pixels included in the first field, and the second image signal 2EP for detection is obtained by reading charge signals from all of pixels included in the second field. However, the present invention is not limited to the preferred embodiments. For example, the first image signal 1EP for detection may be obtained by reading charge signals only from G pixels in a partial area in the pixels included in the first field and the second image signal 2EP for detection may be obtained by reading charge signals only from G pixels in a partial area in the pixels included in the second field.

In the third and fifth preferred embodiments, the charge signals of G pixels neighboring in the J direction are added in the vertical transfer path VC. The present invention, however, is not limited to the preferred embodiments. For example, when the transfer path saturation voltage in the horizontal transfer path is smaller than that in the vertical transfer path, charge signals of G pixels neighboring in the I direction may be added in the horizontal transfer path (horizontal CCD).

The image capturing apparatus 100C according to the third preferred embodiment is adapted to the case where the transfer path saturation voltage is smaller than the pixel saturation voltage. The present invention is not limited to the method. For example, the method of detecting the saturation voltage in the image capturing apparatus 100C may be employed also in the case where the pixel saturation voltage and the transfer path saturation voltage are designated so as to be almost equal to each other and the brightness of the subject is very low. With such a configuration, the saturation voltage can be detected even when the saturation voltage cannot be detected only from the pixel value corresponding to one pixel such as the case where the brightness of the subject is very low.

In the foregoing preferred embodiments, the γ corrector/filter 15 performs the noise reducing process on the image signal digitized by the A/D converter 7. The present invention is not limited to the preferred embodiments. For example, a noise reducing process can be performed by the CDS 5 or the like before the image signal is converted to the digital signal by the A/D converter 7.

Although the first and second image signals 1EP and 2EP for detection are continuously obtained in the foregoing preferred embodiments, the present invention is not limited to the preferred embodiments. The first and second image signals 1EP and 2EP for detection may be obtained with an interval of, for example, about 1 second.

In the foregoing preferred embodiments, the minimum gain set value is set on assumption that the saturation voltage in the image recording standby state of obtaining the first and second image signals 1EP and 2EP for detection and the saturation voltage at the time of image capturing for image recording are almost the same. For example, an image capturing device also exists, which can make the saturation voltage at the time of image capturing for image recording higher than the saturation voltage in the image recording standby state by changing and adjusting the substrate voltage (hereinafter, referred to as “variable voltage image capturing device”). In the case of using the variable voltage image capturing device, if the minimum gain set value is set on assumption that the saturation voltage detected in the image recording standby state is almost equal to the saturation voltage at the time of image capturing for recording, the dynamic range of the image capturing device cannot be fully utilized.

Therefore, in the case of using the variable voltage image capturing device, for example, information of a correlation between the saturation voltage in the image recording standby state and the saturation voltage at the time of image capturing for recording is pre-stored as a look-up table (LUT) in an ROM or the like in the controller 10. The saturation voltage in the image recording standby state detected on the basis of the first and second image signals 1EP and 2EP for detection is multiplied by a coefficient in which the correlation is reflected. On the basis of the saturation voltage multiplied by the coefficient, the minimum gain set value (sensitivity) at the time of image capturing for recording may be set. The correlation may be obtained by, for example, checking the saturation voltage in the image recording standby state and the saturation voltage at the time of image capturing for recording under various conditions (for example, temperature condition) at a designing stage, a manufacturing stage, and the like.

Although the image capturing device of the 2-field reading type has been described as an example in the second and fifth preferred embodiments, the present invention is not limited to the type. For example, an image capturing device of a type having a light-reception part which is divided into three or more fields and reading image signals of all of pixels every field.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image capturing part for capturing an image signal of a subject;
a detector for detecting a saturation voltage of said image capturing part;
an analog amplifier for amplifying said image signal; and
a controller for controlling an amplification factor of said analog amplifier on the basis of said saturation voltage.

2. The image capturing apparatus according to claim 1, further comprising:
an instruction part for instructing start of an image recording preparing operation on the basis of operation of a user, wherein
said detector detects said saturation voltage in response to said instruction of start of said image recording preparing operation by said instruction part.

3. The image capturing apparatus according to claim 1, further comprising:
a noise reduction part for performing a noise reducing process on said image signal, wherein
said noise reduction part changes said noise reducing process on the basis of said saturation voltage.

4. The image capturing apparatus according to claim 1, wherein
said image capturing part captures first and second image signals while setting different exposure amounts, and
said detector detects said saturation voltage on the basis of said first and second image signals.

5. The image capturing apparatus according to claim 4, wherein
said image capturing part adds output signals from a plurality of pixels included in said image capturing part, thereby obtaining said first and second image signals.

6. The image capturing apparatus according to claim 4, wherein
a first exposure is performed on said image capturing part, after that, a second exposure is performed on said image capturing part for exposure time different from exposure time of said first exposure, and said image capturing part reads charge signals accumulated in at least a part of a light-reception part included in said image capturing part at the time of said first and second exposures, thereby obtaining said first and second image signals.

7. The image capturing apparatus according to claim 4, wherein
said image capturing part can read the charge signals accumulated in said light-reception part included in said image capturing part from a plurality of fields including first and second fields, which are obtained by dividing a pixel array in said light-reception part, obtains said first image signal by reading charge signals accumulated in at least a part of said first field at the time of a first exposure, and obtains said second image signal by reading charge signals accumulated in at least a part of said second field at the time of said first exposure and a second exposure.

8. The image capturing apparatus according to claim 4, further comprising:
an electronic flash device for applying light to the subject, wherein
said image capturing part obtains said first and second image signals while setting different exposure amounts in accordance with a light emitting operation of said electronic flash device.

9. The image capturing apparatus according to claim 8, wherein
said electronic flash device performs a first light application, after that, a second light application of a light emission amount different from a light emission amount of said first light application, and
said image capturing part obtains said first image signal by reading the charge signals accumulated in at least a part of a light-reception part included in said image capturing part at the time of said first light application, and obtains said second image signal by reading the charge signals accumulated in at least a part of said light-reception part at the time of said second light application.

10. The image capturing apparatus according to claim 8, wherein
said electronic flash device performs a second light application after a first light application, and
said image capturing part can read the charge signals accumulated in said light-reception part included in said image capturing part from a plurality of fields including first and second fields, which are obtained by dividing a pixel array in said light-reception part, obtains said first image signal by reading charge signals accumulated in at least a part of said first field in first exposure time including a period of said first light application, and obtains said second image signal by reading charge signals accumulated in at least a part of said second field in second exposure time including a period of said first light application and the period of said second light application.

11. The image capturing apparatus according to claim 1, wherein
said controller controls said image capturing apparatus so that said amplification factor to an image signal for detecting said saturation voltage is lower than that to an image signal for generating a live view image.

12. The image capturing apparatus according to claim 1, wherein
said detector detects said saturation voltage on the basis of a first image signal obtained without adding an output signal from a pixel included in said image capturing part and a second image signal obtained by adding output signals from a plurality of pixels included in said image capturing part other than said pixel.

13. The image capturing apparatus according to claim 1, wherein
in the case where a shutter speed value is set to a value larger than a predetermined threshold regarding occurrence of a camera shake in accordance with decrease in brightness of a subject when said amplification factor is held constant, said controller controls said image capturing apparatus so as to increase said amplification factor so that said shutter speed value is not set to a value larger than the predetermined threshold.

14. The image capturing apparatus according to claim 1, wherein
after said saturation voltage becomes equal to or less than a predetermined value, said detector does not detect said saturation voltage until driving of the image capturing part is interrupted.

15. The image capturing apparatus according to claim 1, wherein
said detector detects said saturation voltage at predetermined intervals.

16. A program for making an image capturing apparatus achieve the following functions when executed by a computer included in the image capturing apparatus, the functions of:
obtaining an image signal of a subject by an image capturing part;
detecting a saturation voltage of said image capturing part; and
performing analog amplification on said image signal, wherein
an amplification factor of said analog amplification is controlled on the basis of said saturation voltage.

17. The program according to claim 16, wherein
when executed by said computer, said image capturing apparatus detects said saturation voltage in response to an instruction of start of an image recording preparing operation based on operation of the user.

18. The program according to claim 16, wherein
when executed by said computer, said image capturing apparatus performs a noise reducing process on said image signal and changes said noise reducing process on the basis of said saturation voltage.

19. The program according to claim 16, wherein
when executed by said computer, said image capturing apparatus obtains first and second image signals while setting different exposure amounts, and detects said saturation voltage on the basis of said first and second image signals.

20. The program according to claim 19, wherein
when executed by said computer, said image capturing apparatus obtains said first and second image signals by adding output signals from a plurality of pixels included in said image capturing part.
